(19) United States
(12) Patent Application Publication
(10) Pub. No.: US 2007/0166536 A1
(43) Pub. Date: Jul. 19, 2007

(54) COMPOSITE SHEET

(75) Inventors: Thilo Dollase, Hamburg (DE); Klaus Keite-Telgenbuscher, Hamburg (DE); Aranzazu Escudero Vallejo, Hamburg (DE); Stefan Stadler, Hamburg (DE); Carsten Blank, Tostedt (DE)

Correspondence Address: NORRIS, MCLAUGHLIN & MARCUS, P.A., 875 THIRD AVE, 18TH FLOOR, NEW YORK, NY, 10022, US

(73) Assignee: Teas Aktiengesellschaft, Hamburg (DE)

(21) Appl. No.: 11/616,592

(22) Filed: Dec. 27, 2006

(30) Foreign Application Priority Data
Jan. 18, 2006 (DE) 10 2006 002 596.2

(51) Int. Cl. B32B 7/12; B32B 15/04

(52) U.S. Cl. 428/343; 428/354; 428/355 R

(57) ABSTRACT

The invention relates to a composite sheet. Provision is made for the composite sheet to comprise a polymeric base sheet and a polymeric varnish layer, said varnish layer having

an abrasion resistance, expressed as pencil hardness, of at least 4H; and

a flexibility such that, when the composite sheet is bent around the two closely adjacent edges of a metal strip 100 μm thick, the varnish layer does not break or delaminate from the base sheet;

and said varnish layer having the following optical properties:

a transmittance at 400, 600 and 800 nm of at least 85%, determined by applying the varnish layer-forming formulation with a thickness of 5 μm to a slide, curing the varnish layer and determining the transparency of the slide with the varnish layer in comparison to an uncoated slide; and

a turbidity of not more than 5%, determined by haze measurement.

The invention relates to a composite sheet comprising a base sheet and a varnish layer, and also to a process for producing a composite sheet of this kind, and also the use.

Plastics are long-established materials for diverse applications and are presently employed in a wide variety of forms such as components, as lining elements, and for glazing systems, for example. In many sectors they have replaced conventional materials such as metal, wood, ceramic or silicate glasses in these applications. Certain applications, moreover, would not be practicable at all without plastics. The success story of plastics is without doubt founded in one part on their extremely simple processing. Films, sheets and profiles can be produced advantageously in continuous operations by means, for example, of extrusion. Elements with more complicated geometry can be realized by means of injection-moulding techniques, for example. Shaping methods can be carried out at comparatively low temperatures. Further advantages include the reduced weight as compared with conventional raw materials. In spite of these advantages, however, plastics, depending on their type, also have potential for improvement in specific applications. With plastics, generally speaking, the ageing stability and, more generally, the resistance to external influences do not match that of many conventional materials. Attempts to obtain improved plastic-based materials, in terms of the ageing behaviour, include the use of additives, such as ageing inhibitors, antioxidants and UV protectants. An alternative path to optimizing plastic-based materials and to making them useful for an even broader assortment of applications is to coat the surfaces of the workpieces with a protective varnish. This variant is particularly appropriate when the workpieces are to be made more robust towards a different kind of external influence, namely the mechanical stressing of their surface by abrasion or scratching.

For equipping plastic substrates for resistance to such mechanical stresses there are a multiplicity of varnish systems available, from a range of suppliers. The majority of the varnish formulas available are curable thermally. Hence it is possible to cure coatings fully even on three-dimensional structures with a surface of complex design. In the course of such curing, however, the cure temperatures must not exceed the upper temperature stability limit of the plastic substrates, and depending on type of plastic and on cure mechanism this is not always possible.

In order to get around this problem, therefore, varnish formulas were developed which can be cured by irradiation, particularly by irradiation with ultraviolet radiation or by means of electron beams. One example of applications for polycarbonate substrates is given in U.S. Pat. No. 4,198,465 by General Electric. A curing operation of this kind generally proceeds at relatively low temperatures, so that the thermal load on the plastic substrates is substantially lower than would be the case when using thermosetting protective varnish systems. An overview of the technology of radiation-curable varnishes and diverse possibilities of the use can be gained by studying reviews, which are found for example in Dowbenko and colleagues [R. Dowbenko, C. Friedlander, G. Gruber, P. Prucnal, M. Wismer, Progr. Org. Coat., 1983, 11, 71], in Holamn and Oldring [R. Holman, P. Oldring (Eds.), UV and EB Curing Formulations for Printing Inks, Coatings and Paints, 2nd ed., 1988, SITA Technology, London], in a multi-volume work by Oldring [P. Oldring (Ed.), Chemistry & Technology of UV & EB Formulations for Coatings, Inks & Paints, 1991, SITA Technology, London] or in C. Decker [C. Decker in Materials Science and Technology, R. W. Cahn, P. Hansen, E. J. Kramer (Eds.), volume 18, 1997, Wiley-VCH, Weinheim].

In addition to the shaped articles exemplified above, plastics find broad application, in a further design form, as sheets, which are used for example in the packaging sector or for masking surfaces, whether for decorative reasons or protective purposes, or as base materials for self-adhesive products. In these instances there may likewise be a desire to optimize the resistance of the side exposed to the environment—that is, the part of the sheet exposed to a particularly great extent to external influences—towards, for example, mechanical loading such as abrasion or scratching. Here too, the use of protective varnishes is appropriate.

U.S. Pat. No. 4,557,980 to Martin Processing Inc. describes radiation-curable clear varnishes which are coated in a thickness of between 1 μm and 2.5 μm onto sheet substrates such as polyester films in order to increase the abrasion resistance of the sheet surface. The formulations used in that case are based on acrylates functionalized to different extents. U.S. Pat. No. 4,319,811 to GAF Corp. discloses formulas which are based on a mixture of acrylates of different functionalities, said formulas likewise being radiation-curable and serving to improve the abrasion resistance of, among other things, plastic sheets. Radiation-curable varnish resin formulas for the surface treatment of plastic sheets, therefore, are known.

To improve the abrasion resistance further the literature describes the use of inorganic particles, particularly inorganic nanoparticles, in varnish resin formulations. In this context, formulas have been proposed in which colloidal silica is mixed into the varnish resin formulation, as depicted for example in EP 0 050 996 B1 by Mitsui Petrochemical and in U.S. Pat. No. 4,310,600 by American Hoechst Corp. After curing, these nanoparticles are not chemically linked with the organic network, and the resulting varnish hardnesses are relatively low. In contrast, moreover, formulas are proposed in which particles are employed which have been treated such that a chemical link between particles and varnish resin matrix is formed in the course of curing via the action of coupling reagents. This has been described extensively for particles such as fumed and precipitated silicas, for example. Examples are described in U.S. Pat. No. 4,482,656 to Battelle Corp., in EP 1 153 090 B1 of the Institut fur Oberflächenmodifizierung or by Bauer and colleagues [F. Bauer, V. Sauerland, H.-J. Gläsel, H. Ernst, M. Findeisen, E. Hartmann, H. Langguth, B. Marquardt, R. Mehnert, Macromol, Mater. Eng., 2002, 287, 546]. These publications 25 do not indicate the use of such formulas for the surface treatment of sheet substrates. It is also known that colloidal silica which has been surface-modified in a similar way can be used. Examples of such formulations have been disclosed by, for example, General Electric (see for example U.S. Pat. No. 4,348,462, U.S. Pat. No. 4,478,876 or L. N. Lewis, D. Katsamberis, J. Appl. Polym. Sci., 1991, 42, 1551). In this case as well it is not evident from the 30 publication that corresponding formulations for the surface treatment of sheet substrates had been conceived. Nanoparticle-containing varnish formulas which additionally contain further, very specific constituents are described, in contrast, in JP 01 266 155 by Sunstar and U.S. Pat. No. 5,104,929 by 3M for use additionally on sheet substrates.

Nowadays there are a variety of sheet-formed products known which according to the description have been or can be provided with protective varnishes. The function of the protective varnish in such applications is to increase the resistance of the actual sheet material or of further functional layers present on it towards external influences. Examples are disclosed in U.S. Pat. No. 6,440,551 by CPFilms and in U.S. Pat. Nos. 6,329,041 and 6,638,606 by Dai Nippon Printing, and also in DE 10 2004 046 767 by CKT Folientechnik.

There nevertheless continues to be a need for composite sheets which can be used by way of example, particularly, as decorative sheets, information-carrying sheets or data-storing sheets and for which the optical impression of the decoration, the legibility of the information or the functionality of the data storage in relation to data legibility and/or data writeability is ensured over a long period of time even in spite of mechanical stress to the surface. There is a need, furthermore, for self-adhesive composite sheets having such properties, which can be applied to a substrate that is to be provided, for example, with a decoration, with information or with the capacity for data storage.

It is an object of the invention, therefore, to specify a composite sheet having improved surface properties. A further intention is to specify a process for producing composite sheets of this kind, and also their uses.

This object is achieved through the features of claims 1, 19 and 25. Advantageous embodiments of the invention are evident from the features of claims 2 to 18, 20 to 24 and 26.

In accordance with the invention a composite sheet is provided which comprises a polymeric base sheet and a polymeric varnish layer, said varnish layer having

an abrasion resistance, expressed as pencil hardness, of at least 4H; and

a flexibility such that, when the composite sheet is bent around the two closely adjacent edges of a metal strip 100 μm thick, the varnish layer does not break or delaminate from the base sheet;

and said varnish layer having the following optical properties:

transmittance at 400, 600 and 800 nm of at least 85%, determined by applying the varnish layer-forming formulation with a thickness of 5 μm to a slide, curing the varnish layer and determining the transparency of the slide with the varnish layer in comparison to an uncoated slide; and

a turbidity of not more than 5%, determined by haze measurement.

The abrasion resistance of the varnish layer is determined in accordance with the below-described test B, the flexibility of the varnish layer in accordance with test C, the transmittance of the varnish layer in accordance with test E, and the turbidity in accordance with test F.

The varnish layer ought further to have a surface roughness of not more than 0.3 μm, determined as the average value from three determinations of the greatest height of the surface profile in the coating direction. The surface roughness is determined in accordance with the below-described test D.

On the side of the base sheet facing away from the varnish layer there may be an adhesive layer formed. In this way a single-sidedly self-adhesive composite sheet is obtained. Between the base sheet and the varnish layer there may be further layers. Similarly, between the base sheet and the adhesive layer there may be further layers.

The base sheet, the varnish layer and the adhesive layer may independently of one another be of multi-layer construction. In particular the varnish layer may be constructed from two or more sublayers.

The varnish formulation for producing the varnish layer is preferably free from silicone-containing additives.

The invention makes it possible to produce composite sheets, especially decorative, information-carrying or data-storing sheets, whose functional capacity is protected and therefore preserved by means of a protective varnish coating having a particularly high optical quality, a high flexibility and a high hardness. The composite sheets of the invention, as set out in detail in the description, the example and the claims, can be used over a relatively long period of time and/or under relatively pronounced mechanical loads with substantially consistent quality of the respective function. Products of the invention therefore have a longer lifetime than products not equipped with a varnish layer of the invention. The varnish layer of the invention is also referred to below, in view of its protective function, as protective varnish.

The invention is illustrated below with reference to drawings, in which

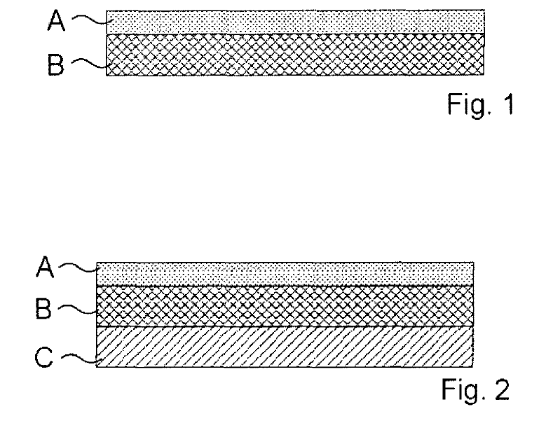

FIG. 1 shows a first embodiment of a composite sheet of the invention, which is composed of a base sheet and a varnish layer; and

FIG. 2 shows a second embodiment of a composite sheet of the invention, which is composed of a base sheet, a varnish layer and an adhesive layer.

The present invention relates to composite sheets which have at least one abrasion-resistant and flexible varnish layer with particularly high optical quality. In one embodiment the composite sheet further comprises an adhesive layer, thus giving a single-sidedly self-adhesive composite sheet. Specific embodiments encompass single-sidedly self-adhesive composite sheets in the form of self-adhesive sheets, tapes and labels. Examples of composite sheets of the invention are therefore, in particular, self-adhesive decorative sheets, self-adhesive information-carrying products and self-adhesive data-storing products, which are coated with the abrasion-resistant and flexible varnish layer of the invention, so that the optical quality of the product surface, i.e., in particular, the optical impression of the decoration, the legibility of the information and/or the functionality of data storage in respect of data legibility and/or data writeability is ensured over a long time even in spite of mechanical stressing of the surface. The composite sheets of the invention comprise web-form sheet materials with a width of preferably at least 30 cm, very preferably at least 50 cm, which according to subsequent use may be or may have been further cut to size or otherwise converted.

According to FIG. 1 the composite sheet of the invention comprises at least one varnish layer A and one base sheet B. The varnish layer A is located on the base sheet B. Between the at least one abrasion-resistant and flexible varnish layer A and the at least one base sheet B there may be an arbitrary number of further layers, of the same of different kind, employed. Mention may be made, as examples of such further layers, of laminating adhesive layers, further base sheets, foamed layers, barrier layers, primer layers, and layers by means of which, themselves and/or in combination with further layers, light can be reflected; this enumeration is not intended to impose any restriction.

In FIG. 2 the composite sheet additionally has an adhesive layer C, which is formed on the side of the base sheet B that faces away from the varnish layer A. The adhesive layer A is preferably a pressure-sensitive adhesive layer. Within the composite of the invention the at least one pressure-sensitive adhesive layer C constitutes the bottommost ply, and the at least one abrasion-resistant and flexible varnish layer A constitutes the topmost ply. The at least one base sheet B is located between these two layers. Between the at least one pressure-sensitive adhesive layer C and the at least one base sheet B there may be an arbitrary number of further layers, of the same or different kind, employed. Likewise, between the at least one abrasion-resistant and flexible varnish layer A and the at least one base sheet B, there may be an arbitrary number of further layers, of the same or different kind, employed. Mention may be made, as examples of such further layers, of laminating adhesive layers, further base sheets, foamed layers, barrier layers, primer layers, and layers by means of which, themselves and/or in combination with further layers, light can be reflected; this enumeration is not intended to impose any restriction.

The single-sidedly self-adhesive composite sheets of the invention are preferably provided, on the side of the at least one pressure-sensitive adhesive layer C, with a release film or release paper, which is removed before the product is applied to the desired substrate.

The at least one abrasion-resistant and flexible varnish layer A provided in accordance with the invention is preferably obtained by curing of radiation-curable formulations. Varnish formulations of the invention typically comprise at least one compound containing at least one (meth)acrylate function, preferably at least two (meth)acrylate functions, and at least one further compound containing at least two (meth)acrylate functions, preferably at least three (meth)acrylate functions. Using further compounds with at least one (meth)acrylate function, but preferably with a higher (meth)acrylate functionality, is advantageous in the sense of this invention.

Where compounds are employed which carry one (meth)acrylate function it is preferred in the sense of this invention to use (meth)acrylate monomers which are specified later on below as monomers for pressure-sensitive adhesives of the advantageously employable pressure-sensitive adhesive layer C, and particularly those conforming to the general structural formula (I). Additionally it is possible to use aliphatic or aromatic, especially ethoxylated or propoxylated polyether mono(meth)acrylates, aliphatic or aromatic polyester mono(meth)acrylates, aliphatic or aromatic urethane mono(meth)acrylates or aliphatic or aromatic epoxy mono(meth)acrylates as compounds which carry one (meth)acrylate function.

As compounds which carry at least two (meth)acrylate functions use is made in accordance with the invention of one or more compounds from the list encompassing difunctional aliphatic (meth)acrylates such as 1,4-butanediol di(meth)acrylate, 1,6-hexanediol di(meth)acrylate, dipropylene glycol di(meth)acrylate, tricyclodecane-dimethylol di(meth)acrylate, trifunctional aliphatic(meth)acrylates such as trimethylolpropane tri(meth)acrylate, tetrafunctional aliphatic(meth)acrylates such as ditrimethylolpropane tetra(meth)acrylate, or ditrimethylolpropane tetra(meth)acrylate, pentafunctional aliphatic(meth)acrylates such as dipentaerythritol monohydroxy-penta(meth)acrylate. hexafunctional aliphatic(meth)acrylates such as dipentaerythritol hexa(meth)acrylate. Further it is possible in accordance with the invention to use aliphatic or aromatic, especially ethoxylated and propoxylated, polyether(meth)acrylates having in particular two, three, four or six (meth)acrylate functions such as ethoxylated bisphenol A di(meth)acrylate, polyethylene glycol di(meth)acrylate, propoxylated trimethylolpropane tri(meth)acrylate, propoxylated glycerol tri(meth)acrylate, propoxylated neopentylglycerol di(meth)acrylate, ethoxylated trimethylol tri(meth)acrylate, ethoxylated trimethylolpropane di(meth)acrylate, ethoxylated trimethylolpropane tri(meth)acrylate, tetraethylene glycol di(meth)acrylate, ethoxylated neopentyl glycol di(meth)acrylate, propoxylated pentaerythritol tri(meth)acrylate, dipropylene glycol di(meth)acrylate, ethoxylated trimethylolpropane methyl ether di(meth)acrylate, aliphatic or aromatic polyester (meth)acrylates having in particular two, three, four or six (meth)acrylate functions, aliphatic or aromatic urethane (meth)acrylates having in particular two, three, four or six (meth)acrylate functions, aliphatic or aromatic epoxy (meth)acrylates having in particular two, three, four or six (meth)acrylate functions. It is further possible for polyunsaturated vinyl ethers to be employed with advantage.

In one further-improved embodiment of this invention the formulations of the invention from which the at least one abrasion-resistant and flexible varnish layer A is obtained comprise at least one kind of inorganic oxides in particulate form. The surface of these particles is preferably functionalized such that the particles not only form a stable suspension in the organic matrix formed by the varnish resin mixture but also can be linked chemically to the organic network that forms in the course of the curing operation.

It is particularly advantageous if surface functionalization of this kind takes place by reaction of the particles with coupling reagents such as, in particular, unsaturated silanes or titanates. In this regard see, for example, L. N. Lewis, D. Katsamberis, J. Appl. Polym. Sci., 1991, 42, 1551, EP 460 560 A2 of Kawasaki Steel, EP 1 366 112 B1 of Hansechemie or U.S. Pat. No. 6,136,912 to Clariant S A. In that case the coupling reagents on the one hand have the possibility to react with groups of the particle surface. Suitable for this purpose are, in particular, alkoxy groups, such as methoxy or ethoxy groups in particular, acetoxy groups and chloride groups. On the other hand the coupling reagents are capable of reacting chemically with the varnish resin formulation as it cures. For this purpose it is appropriate with particular advantage if the coupling reagent contains at least one (meth)acrylate function and/or at least one vinyl function. Particular preference is given to using amorphous silicas or corundum whose average particle diameter is not more than 100 nm, preferably not more than 50 nm, very preferably not more than 25 nm. In varnish formulations in accordance with the invention use is made of up to 50% by weight of inorganic oxide particles of this kind, preferably up to 30% by weight.

Raw materials which can be used with advantage in the sense of this invention are available for example under the brand names Highlink® from Clariant (C. Vu, O. LaFerté, A. Eranian, Eur. Coat. J, 2002, 1-2, 64) and Nanocryl® from Hansechemie (C. Roscher, Eur. Coat. J, 2003, 4, 38).

Formulations of the invention from which the at least one abrasion-resistant and flexible varnish layer A is produced advantageously contain, up to a fraction of 50% by weight, polymers which have a molar mass of at least 5000 g/mol. If such materials are employed, then in one advantageous embodiment of the invention they are substantially free from reactive groups such as, in particular, C—C double bonds. In a further advantageous embodiment, such polymers carry functional groups, such as (meth)acrylate groups, for example, which are able to participate in the curing reaction. Particularly appropriate polymers are (meth)acrylate copolymers, but also others of saturated or unsaturated kind (see, for example, P. K. T. Oldring (Ed.), Chemistry & Technology of UV & EB Formulations for Coatings, Inks & Paints, Vol. 2, 1991, SITA, London, pp. 158-184]. Polymers can be employed advantageously when they are soluble in the mixture of the other varnish resin components.

Varnish formulations of the invention from which the at least one abrasion-resistant and flexible varnish layer A is obtained further comprise, optionally but advantageously, further constituents such as catalysts, accelerators, light stabilizers such as, in particular, UV protectants, ageing inhibitors, antioxidants, further stabilizers, flame retardants, flow control agents, wetting agents, lubricants, defoamers, devolatilizers, adhesion promoters, further Theologically active additives such as thixotropic agents, for example, matting agents and/or further fillers.

In one specific embodiment of the invention the formulations of the invention from which the at least one abrasion-resistant and flexible varnish layer A is obtained are free from silicone-containing additives.

Particularly when the varnish formulation, after having been applied, is cured by electromagnetic radiation, and in that case particularly by UV radiation, at least one kind of a photoinitiator is added to the varnish formulation.

Suitable representatives of such photoinitiators are type I photoinitiators, in other words α-cleaving initiators such as benzoin derivatives and acetophenone derivatives, benzyl ketals or acylphosphine oxides, type II photoinitiators, in other words hydrogen abstractors such as benzophenone derivatives and certain quinones, diketones and thioxanthones. A further possibility is to use triazine derivatives to initiate free-radical reactions.

Photoinitiators of type I which can be employed with advantage include, for example, benzoin, benzoin ethers such as benzoin methyl ether, benzoin isopropyl ether, benzoin butyl ether and benzoin isobutyl ether, for example, methylolbenzoin derivatives such as methylolbenzoin propyl ether, 4-benzoyl-1,3-dioxolane and its derivatives, benzyl ketal derivatives such as 2,2-dimethoxy-2-phenylacetophenone or 2-benzoyl-2-phenyl-1,3-dioxolane, α,α-dialkoxyacetophenones such as α,α-dimethoxyacetophenone and α,α-diethoxyacetophenone, α-hydroxyalkyl phenones such as 1-hydroxycyclohexyl phenyl ketone, 2-hydroxy-2-methyl-1-phenylpropanone and 2-hydroxy-2-methyl-1-(4-isopropylphenyl)propanone, 4-(2-hydroxyethoxy)phenyl-2-hydroxy-2-methyl-2-propanone and its derivatives, α-aminoalkylphenones such as 2-methyl-1-[4-(methylthio)phenyl]-2-morpholinopropan-2-one and 2-benzyl-2-dimethylamino-1-(4-morpholinophenyl)butan-1-one, acylphosphine oxides such as 2,4,6-trimethylbenzoyl-diphenylphosphine oxide and ethyl 2,4,6-trimethylbenzoylphenylphosphinate, and O-acyl α-oximino ketones.

Photoinitiators of type II which can be employed with preference in accordance with the invention include, for example, benzophenone and its derivatives such as 2,4,6-trimethylbenzophenone or 4,4′-bis(dimethylamino)benzophenone, thioxanthone and its derivatives such as 2-isopropylthioxanthone and 2,4-diethylthioxanthone, xanthone and its derivatives, and anthraquinone and its derivatives.

Type II photoinitiators are used with particular advantage in combination with nitrogen-containing coinitiators, known as amine synergists. For the purposes of this invention it is preferred to use tertiary amines. Furthermore, hydrogen atom donors are employed advantageously in combination with type II photoinitiators. Examples of such donors are substrates which contain amino groups. Examples of amine synergists are methyldiethanolamine, triethanolamine, ethyl 4-(dimethylamino)benzoate, 2-n-butoxyethyl 4-(dimethylamino)benzoate, isoacryloyl 4-(dimethylamino)benzoate, 2-(dimethylamino-phenyl)ethanone, and unsaturated and hence copolymerizable tertiary amines, (meth)acrylated amines, unsaturated, amine-modified oligomers and polymers based on polyester or polyether, and amine-modified (meth)acrylates.

It is additionally possible to use polymerizable photoinitiators of type I and/or type II.

For the purposes of this invention it is also possible to use any combinations of different kinds of type I and/or type II photoinitiators.

In any case of sheet coating there is the fundamental difficulty of creating an even balance between hardness and flexibility of the varnish layer. High varnish hardness results in good abrasion resistance of the sheet product. Flexibility, on the other hand, is required, since the sheet base is itself flexible and it is necessary in the course of processing—in other words, for example, when webs are being wound into rolls—and in the course of its use—in other words, for example, when the product is being applied around curvatures or edges—to prevent breaking or flaking of the protective varnish layer from the sheet. It must therefore be ensured that a varnish formulation can be cured to a point where surface tack is no longer present and all of the constituents of the reactive resin have undergone virtually quantitative incorporation into the varnish network, but that the varnish layer is still not brittle.

The at least one abrasion-resistant and flexible varnish layer A employed in composite sheets of the invention is distinguished by the fact that it has a hardness, determined as pencil hardness in accordance with ASTM 3363 (see test B), of at least 4H, preferably at least 7H, and that it has a flexibility, determined in accordance with test C, such that the at least one varnish layer A, when the composite of the invention is bent around the two closely adjacent edges of a metal strip 100 μm thick, corresponding to a deformation of 2×90°=180°, neither breaks nor flakes from the composite.

The at least one abrasion-resistant and flexible varnish layer A has a basis weight of between 0.5 g/m² inclusive and 50 g/m² inclusive, preferably between 2 g/m² inclusive and 15 g/m² inclusive.

The at least one abrasion-resistant and flexible varnish layer A preferably has an extremely low surface roughness. Varnish layers of the invention exhibit a surface roughness in accordance with test D, given by Rz values, of not more than 0.3 μm, preferably not more than 0.15 μm, very preferably not more than 0.08 μm.

The at least one abrasion-resistant and flexible varnish layer is notable, as it were, for particularly high optical quality.

Thus the at least one abrasion-resistant and flexible varnish layer A is preferably transparent. In this version of the invention it has a transmittance at 400 nm, 600 nm and 800 nm of at least 85%, preferably at least 90%, very preferably at least 92%, in accordance with test E.

Thus the at least one abrasion-resistant and flexible varnish layer A has a particularly low turbidity, given by a haze value, determined according to test F, of not more than 5%, preferably not more than 2.5%, very preferably not more than 1%.

To produce the at least one base sheet B it is possible in principle to use all film-forming and/or extrudable polymers. In this regard see, for example, the compilation by Nentwig [J. Nentwig, Kunststofffolien Chapter 5, 2nd ed., 2000, C. Hanser, Munich]. In one preferred embodiment polyolefins are used. Preferred polyolefins are prepared from ethylene, propylene, butylene and/or hexylene, it being possible in each case to polymerize the single monomers, or mixtures of the stated monomers being copolymerized. Through the polymerization process and through the selection of the monomers it is possible to control the physical and mechanical properties of the polymer sheet, such as the softening temperature and/or the tensile strength, for example.

In a further preferred embodiment of this invention polyvinyl acetates are used. Besides vinyl acetate, polyvinyl acetates may also contain vinyl alcohol in comonomer form, the free alcohol fraction being variable within wide limits. In a further preferred embodiment of this invention polyesters are used as the base sheet. In one particularly preferred embodiment of this invention polyesters are used that are based on polyethylene terephthalate (PET) or polybutylene terephthalate (PBT), for example. In another preferred embodiment of this invention polyvinyl chlorides (PVC) are used as the sheet. In order to raise the temperature stability it is possible to prepare the polymer constituents present in these sheets using stiffening comonomers. The sheets may also be radiation-crosslinked in order to obtain a similar improvement in properties. Where PVC is used as raw sheet material, it may optionally include plasticizing components (plasticizers). It is also possible to use other halogenated hydrocarbons as sheet base material, such as polyvinylidene chloride or fluorinated systems, for example. In a further preferred embodiment of this invention polyamides are used for producing sheets. The polyamides may be composed of a dicarboxylic acid and a diamine or of two or more dicarboxylic acids and diamines. Besides dicarboxylic acids and diamines, higher polyfunctional carboxylic acids and amines as well can be used, both alone and in combination with the abovementioned dicarboxylic acids and diamines. To stiffen the sheet it is preferred to use cyclic, aromatic or heteroaromatic starting monomers. In a further preferred embodiment of this invention polymethacrylates are used to produce sheets. Here it is possible to control the glass transition temperature of the sheet through the choice of the monomers (methacrylates and in some cases acrylates as well). The polymethacrylates may further comprise additives as well, in order for example to increase the sheet's flexibility or to raise or lower the glass transition temperature, or to minimize the formation of crystalline segments. In a further preferred embodiment of this invention polycarbonates are used for producing sheets. A further possibility, in a further embodiment of this invention, is to use polymers and copolymers based on vinyl aromatics and vinyl heteroaromatics to produce the at least one base sheet B.

The at least one base sheet B may selectively be present, in particular, in monoaxially oriented, biaxially oriented or unoriented form.

To produce a sheet-form material it may be appropriate to add additives and further components which enhance the film-forming properties, which lower the tendency towards formation of crystalline segments and/or specifically improve the mechanical properties or else, where appropriate, impair the said properties. Further additives for optional use which may be present include ageing inhibitors, light stabilizers such as UV protectants in particular, antioxidants, other stabilizers, flame retardants, pigments, dyes and/or expandants.

The at least one base sheet B may be employed itself as a monolayer construction, or else as a multi-layer composite, obtained for example by coextrusion. The base sheet may additionally have been pretreated and/or provided with a functional layer on one or both sides. Where both sides have been pretreated and/or coated, the nature and/or extent of the pretreatment and/or coating may be different or the same. Such pretreatment and/or coating may serve, for example, for improved anchorage of a further layer, such as the at least one pressure-sensitive adhesive layer C or the at least one varnish layer A, for example, or other layers which may optionally be used. For this purpose it is particularly advantageous if one or both sides of the base sheet are pretreated with one kind or with different kinds of primers and/or if one or both sides of the base sheet are pretreated by corona and/or flame and/or plasma treatment and/or by other methods of surface activation.

The at least one base sheet B may for the purposes of this invention be transparent and colourless or else transparent and coloured. It is also in accordance with the invention if the sheet is not transparent and, moreover, white, grey, black or coloured.

The at least one layer of a base material B has a thickness of between 5 μm inclusive and 500 μm inclusive, preferably between 10 μm inclusive and 100 μm inclusive.

If the composite sheet of the invention is additionally provided with a pressure-sensitive adhesive layer C, then said layer is composed of any prior-art pressure-sensitive adhesive (in this regard see, for example, D. Satas (Ed.), Handbook of Pressure Sensitive Adhesive Technology, 2nd ed., 1989., Van Nostrand Reinhold, New York), and based in particular on acrylate, natural rubber, synthetic rubber or ethylene vinyl acetate. Combinations of these and further systems are also in accordance with the invention. Very great preference is given to employing pressure-sensitive adhesives based on acrylate copolymers.

Examples of pressure-sensitive adhesives which can be employed in accordance with the invention are all polymers of linear, star, branched, graft or other architecture, preferably homopolymers, random copolymers or block copolymers. Examples that may be mentioned, though without wishing to undertake any restriction, of polymers which are particularly advantageous in the context of this invention include random copolymers starting from α,β-unsaturated esters and/or starting from alkyl vinyl ethers. Particular preference is given to using α,β-unsaturated alkyl esters of the general structure

CH₂═CH(R¹)(COOR²) (I)

where R¹═H or CH₃ and R²═H or linear, branched or cyclic, saturated or unsaturated alkyl radicals having 1 to 30 carbon atoms.

Monomers employed with very great preference in the sense of the general structure (I) include acrylic and methacrylic esters with alkyl groups consisting of 4 to 18 carbon atoms. Specific examples of such compounds, without wishing to be restricted by this enumeration, include n-butyl acrylate, n-pentyl acrylate, n-hexyl acrylate, n-heptyl acrylate, n-octyl acrylate, n-nonyl acrylate, lauryl acrylate, hexadecyl acrylate, stearyl acrylate, stearyl methacrylate, behenyl acrylate, branched isomers thereof, such as 2-ethylhexyl acrylate, isooctyl acrylate, isodecyl acrylate and tridecyl acrylate, and also cyclic monomers such as cyclohexyl acrylate, tetrahydrofurfuryl acrylate, dihydrodicyclopentadienyl acrylate, 4-tert-butylcyclohexyl acrylate, norbornyl acrylate and isobornyl acrylate, for example.

Likewise possible for use as monomers are acrylic and methacrylic esters containing aromatic radicals, such as phenyl acrylate, benzyl acrylate, phenyl methacrylate, benzyl methacrylate, phenoxyethyl acrylate, ethoxylated phenol acrylate or ethoxylated nonylphenol acrylate, for example.

A further possibility, optionally, is to use vinyl monomers from the following groups: vinyl esters, vinyl ethers, vinyl halides, vinylidene halides, and vinyl compounds containing aromatic rings or heterocycles in α position. For the vinyl monomers which may optionally be employed mention may be made, by way of example, of selected monomers which can be employed in accordance with the invention: vinyl acetate, vinylcaprolactam, vinylformamide, vinylpyridine, ethyl vinyl ether, 2-ethylhexyl vinyl ether, butyl vinyl ether, vinyl chloride, vinylidene chloride, acrylonitrile, styrene and α-methylstyrene.

Further monomers which can be employed in accordance with the invention are glycidyl methacrylate, glycidyl acrylate, allyl glycidyl ether, 2-hydroxyethyl methacrylate, 2-hydroxyethyl acrylate, 3-hydroxypropyl methacrylate, 3-hydroxypropyl acrylate, 4-hydroxybutyl methacrylate, 4-hydroxybutyl acrylate, acryloylmorpholine, methacryloylmorpholine, trimethylolpropane formal monoacrylate, propoxylated neopentyl methyl ether monoacrylate, tripropylene glycol methyl ether monoacrylate, ethoxylated ethyl acrylate such as ethyl diglycol acrylate, propoxylated propyl acrylate, acrylic acid, methacrylic acid, itaconic acid and its esters, crotonic acid and its esters, maleic acid and its esters, fumaric acid and its esters, maleic anhydride, methacrylamide and N-alkylated derivatives such as N-methylolmethacrylamide, acrylamide and N-alkylated derivatives such as N-methylolacrylamide, vinyl alcohol, 2-hydroxyethyl vinyl ether, 3-hydroxypropyl vinyl ether and 4-hydroxybutyl vinyl ether.

In the case of synthetic or other rubber as starting material for the pressure-sensitive adhesive, there are further possibilities for variation, whether from the group of the natural rubbers or the synthetic rubbers or whether from any desired blend of natural rubbers and/or synthetic rubbers, it being possible in principle to select the natural rubber or natural rubbers from all available grades such as, for example, crepe, RSS, ADS, TSR or CV grades, depending on the required purity level and viscosity level, and to select the synthetic rubber or synthetic rubbers from the group of randomly copolymerized styrene-butadiene rubbers, butadiene rubbers, synthetic polyisoprenes, butyl rubbers, halogenated butyl rubbers, acrylate rubbers, ethylene-vinyl acetate copolymers and polyurethanes and/or blends thereof.

Tackifying resins which can be employed optionally in the pressure-sensitive adhesive layer C include, without exception, all known tackifier resins and tackifier resins described in the literature. Representatives which may be mentioned include rosins, their disproportionated, hydrogenated, polymerized and esterified derivatives and salts, the aliphatic and aromatic hydrocarbon resins, terpene resins and terpene-phenolic resins. Any desired combinations of these and further resins may be employed in order to adjust the properties of the resultant adhesive in accordance with requirements.

As plasticizers which can likewise be employed optionally it is possible to use all plasticizing substances known from the technology of self-adhesive tapes. They include, among others, the paraffinic and naphthenic oils, (functionalized) oligomers such as oligobutadienes and oligoisoprenes, liquid nitrile rubbers, liquid terpene resins, vegetable and animal fats and oils, phthalates and functionalized acrylates. Pressure-sensitive adhesives as indicated above may also include further constituents such as additives with a rheological activity, catalysts, initiators, stabilizers, compatibilizers, coupling reagents, crosslinkers, antioxidants, other ageing inhibitors, light stabilizers, flame retardants, pigments, dyes, fillers and/or expandants.

Where a pressure-sensitive adhesive layer C is employed, the pressure-sensitive adhesive is selected for the purposes of this invention such that its adhesive properties and its ageing stability meet the requirements imposed on the single-sidedly self-adhesive products overall with regard to temporary, long-lasting or permanent fixing on a desired substrate.

The pressure-sensitive adhesive in the pressure-sensitive adhesive layer C is preferably transparent and colourless or else transparent and coloured. It may also not be transparent and, moreover, white, grey, black or coloured.

The pressure-sensitive adhesive layer C has a basis weight of between 2 g/m² inclusive and 500 g/m² inclusive, preferably between 5 g/m² inclusive and 100 g/m² inclusive.

For the purposes of this invention it is possible to select in principle any of the methods known to the skilled worker in order to apply the varnish formulations of the invention to sheets. Without wishing to be bound by any restriction, mention may be made, by way of example, of knife-coating methods, roller methods, such as patterned roller methods in particular, dipping methods, spraying methods, blade methods, brush methods, casting methods and printing methods, such as offset or flexographic printing methods in particular. Combinations of different methods are also conceivable in this context, such as, for example, the Mayer bar method, a coating operation which combines rollers and knives with one another, or roll/casting systems, in which rollers and knives are combined with one another and, additionally, the principle of casting coating is incorporated. A number of methods which can be employed in accordance with the invention are to be found, for example, in Scharenberg [R. T. Scharenberg in Encyclopedia of Polymer Science and Engineering, H. F. Mark, N. M. Bikales, C. G. Overberger, G. Menges (Ed.), Volume 3, 2nd ed., 1985, Wiley, New York].

Preference is given in accordance with the invention to employing methods of the kind which, for the at least one varnish layer A, lead to a surface roughness by test D with Rz values of not more than 0.3 μm, preferably not more than 0.15 μm, very preferably not more than 0.08 μm.

In order to eliminate atmospheric oxygen, which has an inhibiting effect on varnish curing, it is possible for the purposes of this invention to employ all prior-art methods and also combinations of different such methods.

The literature has proposed diverse possibilities as to how the adverse effect of atmospheric oxygen on the curing operation can be suppressed. A range of original studies which describes such ways is summarized by Studer et al. [K. Studer, C. Decker, E. Beck, R. Schwalm, Progr. Org. Coat., 2003, 48, 92]. In this compilation, for instance, the use of amines; the use of substances capable of converting triplet oxygen into singlet oxygen; an increased amount of photoinitiator employed; a higher UV dose; the introduction of protective layers based on wax or on water films; a higher monomer reactivity; and a higher viscosity on the part of the varnish formulation are all said to be beneficial in suppressing the inhibiting effect of atmospheric oxygen. Specific types of photoinitiator have been tested for the same purpose [H. J. Hageman, L. G. J. Jansen, Makromol. Chem., 1988, 189, 2781].

One elegant way is the displacement of atmospheric oxygen through use of an inert atmosphere such as nitrogen, argon or carbon dioxide. Examples of such methods have been published some time ago in U.S. Pat. No. 3,840,448 by Union Carbide Corp. and recently by Studer et al. [K. Studer, C. Decker, E. Beck, R. Schwalm, Progr. Org. Coat., 2003, 48, 92 and also ibid, 101].

With particular preference the coating of the varnish formulation onto the sheet web of the base sheet B is followed by covering with a protective sheet, in wet form, and, subsequently, by irradiation through this protective sheet and, accordingly, curing [A. van Neerbos, J. Oil Col. Chem. Assoc., 1978, 61, 241]. The coated and irradiated base sheet B forms onto the composite sheet and can then be processed further together with the protective sheet—that is, for example, can be wound up into bales or supplied directly to slitting or diecutting operations. The protective sheet is removed at any point in time between the at least one curing step and the application of the composite sheet of the invention, in the course of its use. Removal takes place preferably prior to the converting of the web-form material and very preferably prior to any winding up of the web-form material into bales.

The protective sheet is preferably transparent, particularly if electromagnetic radiation such as UV radiation is employed for curing. As sheet materials for protective sheets which can be used in accordance with the invention it is possible in principle to use all those which after the liquid varnish layer has been crosslinked can be delaminated again without damaging the varnish layer, which at that point is substantially cured. It is important, therefore, that the sheet surface does not react chemically with the curing varnish layer. For this purpose the protective sheet can also be provided with a special layer, such as, for example, a release layer, such as, for example, siliconization or a release layer based on polyolefins, especially polyethylene, or based on partly fluorinated or perfluorinated hydrocarbons, particularly those of polymeric nature. In the inventive sense it is possible for example to use polyolefin films or polyester films as have been described in the literature [EP 50 996 B1 of Mitsui Petrochemical; C. Peinado, E. F. Salvador, A. Alonso, T. Corrales, J. Baselga, F. Catalina, J. Polym. Sci. A—Polym. Chem., 2002, 40, 4236] or others which meet this requirement.

Protective sheets employed with particular preference are those types of sheets which in addition to the criteria set out above additionally have a defined roughness on the side facing the varnish layer. For high-value optical applications in particular, in certain circumstances, a gloss which is perceptible to the human eye [P. Dufour in Chemistry & Technology of UV & EB Formulation for Coatings, Inks & Paints, P. K. T. Oldring (Ed.), Volume 1, 1991, SITA Technology, London, p. 27] is not sufficient as a criterion for the surface quality of protective sheets which can be used. The possibility of protective sheets for use is instead determined by test D by way of the surface roughness and also by way of the turbidity via the haze value according to test F. Protective sheets which can be employed with particular preference in accordance with the invention have a roughness according to test D, on the side facing the varnish layer, which is given by Rz values of not more than 0.3 μm, preferably not more than 0.15 μm, very preferably not more than 0.08 μm. They exhibit a haze value according to test F of not more than 5%, preferably not more than 2.5%, very preferably not more than 1%.

After the application of the varnish formulation from which, by crosslinking, the at least one abrasion-resistant and flexible varnish layer A of particularly high optical quality is obtained, and after the operation of covering with a protective sheet, which is optional but with particular preference is carried out, the operation takes place of curing the liquid varnish layer. For the purposes of this invention this is done using radiation-chemical methods. These include exposure to electromagnetic radiation such as, in particular, UV radiation and/or to particulate radiation such as, in particular, electron beams. By means of short-term exposure to light in a wavelength range between 200 to 500 nm and/or to accelerated electrons, the coated varnish material is irradiated and hence cured. In the case of UV irradiation, use is made in particular of high-pressure or medium-pressure mercury lamps at an output of 80 to 240 W/cm. Further radiation sources which can be employed for the purposes of this invention are familiar to the skilled person. The emission spectrum of the lamp is tailored selectively to the photoinitiator employed, or the nature of the photoinitiator is adapted to the lamp's spectrum. The irradiation intensity is adapted to the respective quantum yield of the UV photoinitiator and to the web speed.

Where irradiation with accelerated electrons is employed to cure the varnish layer A, which can also be done in combination with UV crosslinking, typical irradiation equipment then includes linear cathode systems, scanner systems, or segmented cathode systems when electron beam accelerators are involved. Typical acceleration voltages are situated within the range between 50 kV and 1 MV, preferably 80 kV and 300 kV. The irradiation doses employed lie between 5 to 250 kGy, in particular between 20 and 100 kGy.

The composite sheets of the invention are used preferably for decorative purposes, as robust information-carrying articles and/or in products or as products that can be utilized for the purpose of data storage.

Inventive composite sheets that are employed for decorative purposes comprise decorative elements for example, but preferably, in the form of printing, which is located on any layer of the composite sheet of the invention beneath the at least one abrasion-resistant and flexible varnish layer A. Decorative elements may, for example, be patterns of any kind. It is also possible for the purposes of this invention for at least one arbitrary layer of the composite sheet of the invention to be white, grey, black or coloured. If the said at least one layer is coloured, it may additionally and selectively be transparent or non-transparent. Single-sidedly self-adhesive composite sheets of this kind are employed preferably in the form of self-adhesive sheets, cut into any desired shapes, in order to provide any desired substrates with the corresponding decoration contained in the composite sheet. If, for example, the product is coloured and transparent, then it can be used to provide glazing systems with colour in a simple way. The at least one abrasion-resistant and flexible varnish layer A ensures in that case that the visual impression, such as, for example, the gloss of the surface, if the varnish has been formulated thus, is preserved over a relatively long period of time, in spite of mechanical stress, than would be the case in a comparative product without a protecting varnish layer. Similarly, any desired components, including surface-mounted automotive components or parts of cars, can be overstuck with composite sheets of the invention, single-sidedly self-adhesive composite sheets in particular, and hence made white, grey, black or coloured, for example, in a simple way, when the composite sheet of the invention is configured such that at least one layer of the composite sheet is white, grey, black or coloured. This enumeration can be understood only as an example of the inventive use of composite sheets of the invention. A multiplicity of further design possibilities and uses are likewise possible.

Composite sheets of the invention which carry information contain this information for example, but preferably, in the form of printing, which is located on any layer of the composite sheet of the invention beneath the at least one abrasion-resistant and flexible varnish layer A. Information may be, in particular, any combinations of alphanumeric symbols, barcodes, logos and/or patterns of any kind. Other kinds of information are likewise possible for the purposes of this invention. If the composite sheets are self-adhesive, they are employed preferably as self-adhesive labels, cut to size or diecut into any shapes, for the purpose of imparting the corresponding information in the product to any desired substrates. The at least one abrasion-resistant and flexible varnish layer A ensures in this case that the legibility of the information is preserved over a longer period of time, in spite of mechanical stress, than would be the case in a comparative product without a protecting varnish layer. As a result of the at least one pressure-sensitive adhesive layer C the product of the invention is readily applied to any desired substrates. Again, the applications specified here for information-carrying products are to be understood only as examples. A multiplicity of further design possibilities and uses are likewise possible.

Composite sheets of the invention that offer the capacity for data storage comprise this data storage capacity in or on any layer of the composite sheet of the invention. Data storage is possible in particular in the form of holograms, which can be written to and/or read from the corresponding layer by means of a laser. Such data may be, in particular, any desired combinations of alphanumeric symbols, barcodes, logos and/or patterns of any kind. Further kinds of data are likewise possible for the purposes of this invention. Data may additionally be stored, in the composite sheets of the invention, in the form of individual holograms, individual microtexts, individual microscripts and/or individual images, it being possible for the individual holograms to contain as data not only digital information but also microtexts, microscripts and/or microimages. Self-adhesive embodiments of composite sheets of this kind are employed preferably as self-adhesive labels, cut to size or diecut into any shapes, for the purpose of imparting data present in the product, and/or the capacity to write data to the product, to any desired substrates. The at least one abrasion-resistant and flexible varnish layer A in this case ensures that the legibility and/or writeability of data is or are preserved over a longer period of time, in spite of mechanical stress, than would be the case in a comparative product without a protecting varnish layer. As a result of the at least one pressure-sensitive adhesive layer C, the composite sheet of the invention can be applied readily to any desired substrates. Again, the applications of data-carrying products that are specified here are to be understood only as examples. A multiplicity of further design possibilities and uses are likewise possible.

Test methods

Test A: Basis Weight of Varnish

A circular cutter was used to cut five test specimens A from a coated sample, and the total weight was determined by weighing. A circular cutter was used likewise to cut five test specimens B from uncoated raw material, as a reference, and the total weight was determined by weighing. The basis weight, i.e. the weight of varnish per unit area, is one fifth of the difference between the total weight of the five test specimens A and the total weight of the five test specimens B. The basis weight is reported in g/m².

Test B: Pencil Hardness of Varnish

The pencil hardness of the varnish was determined in accordance with ASTM D3363. An inventive composite sheet specimen is placed on a flat, smooth, firm surface, with the varnish facing upwards. The hardness test was carried out using a set of pencils of different hardnesses (from 9B, the softest, to 9H, the hardest) of the Derwent Graphic Pencils type from Derwent, United Kingdom. The individual pencils were sharpened prior to each test. The points were then flattened at an angle of 90°, using Superflex KJ-RR 16-I P600 sandpaper from Saint-Gobain Gerva B. V., so that a circular area was formed at the beginning of the lead. Pencils of different hardnesses were drawn by the tester over the test surface in succession, at an angle of 45°. The varnish is assigned the pencil hardness corresponding to the hardest pencil which just left no visible track in the varnish. If the hardest pencil (9H) does not score the varnish, the result is reported as >9H.

Test C: Flexibility of Composite Sheet

A specimen of the composite sheet is folded in an angle of 180° around the two closely adjacent side edges of a flat, burr-free metal strip of a defined thickness and an examination is made as to whether the varnish layer breaks or flakes off in the region of maximum bending. For this purpose a Horex® feeler gauge strip from Preisser with a thickness of 100 μm is used. The specimen is placed firmly around the two edges in such a way that the air inclusions in the edge region are no longer visible to the eye. During the test, the varnish is located on the side of the composite which does not point to the feeler gauge strip. If the varnish withstands this stress, the test result is reported as a “pass”. If the varnish breaks under this stress or undergoes flaking from a bottom ply, the result of the test is reported as a “fail”.

Test D: Surface Roughness of the Varnish Layer A and of the Protective Sheet

The surface roughness of the protective sheet and of the cured varnish layer A on a base sheet is determined using a perthometer PGK from Mahr, equipped with an MFW250 feeler tip. The samples are cut into test specimens measuring approximately 10 cm×10 cm, and fastened to the measuring plate by magnets. The conical feeler tip is moved carefully towards the specimen so that it is just in contact with the surface of the specimen. The lateral measuring range is ±25 μm. The feeler tip is then run over the test specimen in a straight line over a distance of 1.75 mm at a speed of 0.1 mm/s, and in the course of this operation any vertical deflections are recorded and used to construct a vertical profile. From the raw data, the surface roughness is evaluated in accordance with DIN EN ISO 4287 as the greatest height of the profile Rz. Three measurements are carried out in each case, in the direction of coating, and the average of the individual measurements is stated in μm.

Test E: Transparency of the Varnish Layer A and of the Protective Sheet

A slide of the kind used in optical microscopy (from Paul Marienfeld GmbH & Co KG, Lauda-Königshofen, for example) is coated with a weight of 5 μm with the varnish formulation under investigation and intended to form varnish layer A, and is subsequently cured. The transmittance is measured in a twin-beam UVIKON 923 UV/VIS spectro-photometer from Bio-Tek Kontron Instruments, at wavelengths of 400 nm, 600 nm and 800 nm. The reference used is an uncoated slide of the same kind as that referred to above. For each measurement wavelength, the transmittance is reported as a percentage of the irradiated light intensity.

The transmittance of the protective sheet is determined by placing a sheet specimen into the aforementioned UV-VIS spectrometer. The transmittance is determined at 400 nm against air as reference and is expressed in % of the irradiated intensity.

Test F.: Turbidity of the Varnish Layer A and of the Protective Sheet (Haze)

To determine the turbidity of the protective sheet and of the cured varnish layer A on a base sheet, the principle of the Ulbricht sphere was employed. A getSphere-80 measuring sphere from getSpec was used. The light source employed was an HL2000 halogen lamp from Mikropack. Prior to the measurement, calibration was carried out using a perfect diffuser (white reference, getSpec) and a perfect reflector (optical mirror). The reflection spectrum was recorded in the entire visible range and evaluated at 650 nm. The turbidity (haze) is reported in % of the irradiated intensity.

### EXAMPLES

A radiation-curable varnish formulation for producing varnish layer A, which as well as other ingredients included a difunctional acrylate, a trifunctional acrylate and a photoinitiator, was coated by means of a 0 doctor knife (wire doctor knife with a wire diameter of 0.05 mm from RK Print Coat Instruments) onto a polyethylene terephthalate polyester sheet 50 μm thick, as base sheet B, and this coating was covered with an inventively selected 50 μm polyethylene terephthalate polyester sheet by lamination using a rubber roller. The polyester sheet used for covering had a test E transparency at 400 nm of 86% and a test D surface roughness on the side pointing towards the varnish of Rz 0.025 μm. The haze value of the sheet was 0.38%. The composite was subsequently cured through the cover sheet with UV radiation (25 mJ/cm² UV-C; Hg lamp, undoped, Eltosch). The cover sheet was subsequently removed without destruction or residue. The varnish layer C showed no traces of coating evident to the eye, was fully cured, and had a test A basis weight of 2.8 g/m² and a test B pencil hardness of 6H. The flexibility of the varnish according to test C was determined with the result “pass”. The varnish was found to have a surface roughness of Rz=0.027 μm. Varnish layer C had a test E transmittance of 99.0% at 400 nm, 99.6% at 600 nm and 99.9% at 800 nm wavelength. The coated varnish had a haze value of 0.32%.

The composite sheet, moreover, was laminated on the non-abrasion-resistantly treated side of the base sheet B, with an acrylate-based adhesive transfer tape, representing the adhesive layer C. In this way it was easy to apply the composite sheet to any desired substrates.

1. Composite sheet comprising a polymeric base sheet and a polymeric varnish layer, said varnish layer having
an abrasion resistance, expressed as pencil hardness, of at least 4H; and
a flexibility such that, when the composite sheet is bent around the two closely adjacent edges of a metal strip 100 μm thick, the varnish layer does not break or delaminate from the base sheet;
and said varnish layer having the following optical properties:
a transmittance at 400, 600 and 800 nm of at least 85%, determined by applying the varnish layer-forming formulation with a thickness of 5 μm to a slide, curing the varnish layer and determining the transparency of the slide with the varnish layer in comparison to an uncoated slide; and
a turbidity of not more than 5%, determined by haze measurement.

2. Composite sheet according to claim 1, characterized in that the varnish layer has a surface roughness of not more than 0.3 μm, determined as the average value from three determinations of the greatest height of the surface profile in the coating direction.

3. Composite layer according to claim 1, wherein the varnish layer has a basis weight of 0.5 to 50 g/m².

4. Composite layer according to claim 1, wherein the varnish layer is of multi-layer construction.

5. Composite layer according to claim 1 wherein the varnish layer is coated onto the base sheet.

6. Composite sheet according to claim 1, wherein between the varnish layer and the base sheet there is at least one further layer.

7. Composite sheet according to claim 1, wherein the varnish layer is produced from a formulation comprising at least one compound containing at least one (meth)acrylate function and at least one compound containing at least two (meth)acrylate functions.

8. Composite sheet according to claim 1, wherein the varnish layer is produced from a formulation which is free from silicone-containing additives.

9. Composite sheet according to claim 1, wherein the base sheet has a layer thickness of 5 μm to 500 μm.

10. Composite sheet according to claim 1, wherein the base sheet has a multi-layer construction.

11. Composite sheet according to claim 1, wherein the base sheet is transparent and colourless; transparent and coloured; or not transparent and coloured.

12. Composite sheet according to claim 1, wherein the base sheet has been produced from a polyolefin, a polyvinyl acetate and/or a polyester.

13. Composite sheet according to claim 1, further comprising an adhesive layer.

14. Composite sheet according to claim 13, characterized in that the adhesive layer is disposed on the side of the base sheet that faces away from the varnish layer.

15. Composite sheet according to claim 13, wherein the adhesive layer is formed from a pressure-sensitive adhesive.

16. Composite sheet according to claim 13, wherein the pressure-sensitive adhesive has a basis weight of 2 g/m² to 500 g/m².

17. Composite sheet according to claim 13, wherein the pressure-sensitive adhesive is prepared from a random copolymer obtained from a formulation which comprises α,β-unsaturated alkyl esters of the general structure (I)
CH₂═CH(R¹)(COOR²) (I)
where R¹═H or CH₃ and R²═H or linear, branched or cyclic, saturated or unsaturated alkyl radicals having 1 to 30 carbon atoms.

18. Composite sheet according to claim 13, wherein the base sheet is transparent and colourless; transparent and coloured; or not transparent and coloured.

19. Process for producing the composite sheet claim 1, comprising
applying the varnish formulation forming the varnish layer to the base sheet; and
curing the varnish formulation to form the varnish layer.

20. Process according to claim 19, characterized in that the varnish formulation is applied in web form with a working width of at least 30 cm to the base sheet.

21. Process according to claim 20, characterized in that the varnish formulation is applied in web form with a working width of at least 50 cm to the base sheet.

22. Process according to claim 19, wherein, after the varnish formulation has been applied to the base sheet and before the varnish formulation is cured, the varnish formulation is covered on the side facing away from the base sheet with a protective sheet.

23. Process according to claim 22, characterized in that the protective sheet is removed after the varnish layer has been cured and before the composite sheet is applied to a substrate.

24. Process according to claim 19, wherein the adhesive layer is applied to the base sheet before or after the varnish formulation is applied to the base sheet.

25. A decorative, information-carrying or data-containing sheet or to a coated substrate comprising the composite sheet of claim 1.

26. The coated substrate of claim 25, wherein said substrate is an automotive component or a part of cars a car.

27. A self-adhesive sheet, tape or label comprising a single sidedly self-adhesive composite sheet of claim 1.

28. A decoration-carrying, information-carrying and/or data-containing self-adhesive tape, sheet or label comprising a single-sidedly self-adhesive composite sheet of claim 1.

29. A decoration carrying, information-carrying or data-containing self-adhesive tape, sheet or label of claim 28 wherein said decoration, information or data are holograms, microtexts, microscripts and/or images, the data content of said individual holograms optionally including not only digital information but also microtexts, microscripts and/or microimages.

30. A method for fixing decoration, information and/or data on packaging, products, components, automotive parts or parts of cars, which comprises fixing said decoration, information and/or data on said packaging, products, components, automotive parts or parts of cars with the single-sidedly self-adhesive composite sheet of claim 28.

31. Composite sheet according to claim 14, wherein the adhesive layer is formed from a pressure-sensitive adhesive.
